(19) United States
(12) Patent Application Publication
(10) Pub. No.: US 2013/0083643 A1
(43) Pub. Date: Apr. 4, 2013

(54) OPTICAL PICKUP APPARATUS

(71) Applicants: Sanyo Electric Co., Ltd., Moriguchi-city (JP); Sanyo Optec Design Co., Ltd., Ora-gun (JP)

(72) Inventors: Hitoshi OGURA, Isesaki-shi (JP); Kiyoshi HIBINO, Gifu-shi (JP)

(73) Assignees: SANYO OPTEC DESIGN CO., LTD., Ora-gun (JP); SANYO ELECTRIC CO., LTD., Moriguchi-city (JP)

(21) Appl. No.: 13/632,292

(22) Filed: Oct. 1, 2012

(30) Foreign Application Priority Data
Sep. 29, 2011 (JP) 2011-213658

(51) Int. Cl. G11B 7/00

(52) U.S. Cl. 369/100; G9B/7

(57) ABSTRACT

An optical pickup apparatus including a photodetector including first to fourth quadrant light-receiving portions, a first generating unit configured to generate a focus error signal based on respective signals from the first to fourth light-receiving portions, a second generating unit configured to generate a tracking error signal based on respective signals from the first to fourth light-receiving portions, first to fourth low-pass filters configured to allow respective signals to be input thereto from the first to fourth light-receiving portions, a third generating unit configured to generate a first correction signal for correcting the focus error signal by performing subtraction on an addition signal obtained by adding respective signals from the first and fourth low-pass filters, and an addition signal obtained by adding respective signals from the second and third low-pass filters, and a correction unit configured to correct the focus error signal based on the first correction signal.

### CROSS-REFERENCE TO RELATED APPLICATION

This application claims the benefit of priority to Japanese Patent Application No. 2011-213658, filed Sep. 29, 2011, of which full contents are incorporated herein by reference.

### BACKGROUND OF THE INVENTION

1. Field of the Invention

The present invention relates to an optical pickup apparatus configured to be capable of carrying out operations for reading signals recorded on an optical disc and recording signals on the optical disc.

2. Description of the Related Art

An optical disc apparatus capable of carrying out signal reading operations and signal recording operations by making an optical pickup apparatus irradiate laser light onto a signal recording layer of an optical disc is widely used.

As optical disc apparatuses handling optical discs, such as CDs and DVDs, are commonly used, while optical disc apparatuses handling optical discs with improved recording density, i.e., optical discs conforming to the Blu-ray standard has been developed recently. Among the aforementioned optical discs, multilayer-type optical discs having a plurality of signal recording layers have been commercialized recently.

An optical pickup apparatus incorporated into an optical disc system is configured to guide laser light emitted from a laser diode to an objective lens and thereafter applied, onto a signal recording layer formed on an optical disc, as a laser spot through focusing the laser light with the objective lens.

The optical pickup apparatus is configured to carry out a focus control operation of focusing laser light onto the signal recording layer and a tracking control operation causing a laser spot to follow a signal track formed on the signal recording layer.

The focus control operation guides laser light reflected by the signal recording layer formed on the optical disc that is the laser light referred to as optical feedback, to a photodetector and utilizes a focus error signal generated based on a signal from a light-receiving portion incorporated in the photodetector.

Among various methods of focus control operation, an astigmatic method is a widely adopted method according to which a focus error signal is generated by a quartered light-receiving portion that is divided into quadrants in a tracking direction and a direction perpendicular thereto. According to the astigmatic method, however, the vicinity of a target focal point is apt to be influenced by disturbance caused by the irregular shape of the guide groove and the like formed on the optical disc, which brings about a problem that an error would occur during focus error signal detection.

As a method of solving such a problem, a differential astigmatic method has been developed, according to which a laser light emitted from a laser diode is divided into a main beam and two subbeams, and thereafter disturbance included in a focus error signal from the main beam is eliminated through subtraction using a signal obtained from the subbeam that is reverse in phase to the focus error signal (see Japanese Laid-Open Patent Publication No. 2010-153011).

The aforementioned focus control method utilizing three beams, i.e., the differential astigmatic method, offers an advantage of highly accurate error detection and also enables stable error detection operation. The method, however, requires a diffraction grating that divides laser light into three laser beams. This not only poses a problem of increase in cost of the optical pickup apparatus but also the need to improve the positioning accuracy when mounting the diffraction grating.

In a case of an optical pickup apparatus for recording/reproducing configured to have functions for reading signals recorded on an optical disc and recording signals on the optical disc as well, the light quantity of the main beam that carries out signal recording would decrease since the laser light is divided into three laser beams. This leads to a problem that the output of laser light generated by a laser diode needs to be increased in order to carry out recording operation.

An optical pickup apparatus configured to be capable of reading signals recorded on a multilayer optical disc with a plurality of signal recording layers has a problem that the main beam reflected by a signal recording layer from which signal reading is not carried out, that is, laser light referred to as stray light, is emitted onto a light-receiving portion provided to receive optical feedback of a subbeam and thereby exerts negative effect on focus error signal generation.

### SUMMARY OF THE INVENTION

An optical pickup apparatus according to an aspect of the present invention, includes: a photodetector including first to fourth light-receiving portions obtained by dividing the photodetector into four portions along a first direction optically corresponding to a direction orthogonal to a tracking direction and a second direction optically corresponding to the tracking direction, the photodetector configured to be irradiated with a laser light applied to a signal recording layer of an optical disc and thereafter reflected by the signal recording layer of the optical disc; a first generating unit configured to generate a focus error signal by performing subtraction on a first addition signal obtained by adding respective signals from the first and third light-receiving portions, arranged in one diagonal direction, among the first to fourth light-receiving portions, and a second addition signal obtained by adding respective signals from the second and fourth light-receiving portions arranged in another diagonal direction among the first to fourth light-receiving portions; a second generating unit configured to generate a tracking error signal by performing subtraction on a third addition signal obtained by adding respective signals from the first and fourth light-receiving portions arranged in the first direction, and a fourth addition signal obtained by adding respective signals from the second and third light-receiving portions arranged in the first direction; first to fourth low-pass filters configured to allow respective signals to be input thereto from the first to fourth light-receiving portions; a third generating unit configured to generate a first correction signal for correcting the focus error signal by performing subtraction on a fifth addition signal obtained by adding respective signals from the first and fourth low-pass filters, and a sixth addition signal obtained by adding respective signals from the second and third low-pass filters; and a correction unit configured to correct the focus error signal based on the first correction signal.

Other features of the present invention will become apparent from descriptions of this specification and of the accompanying drawings.

### BRIEF DESCRIPTION OF THE DRAWINGS

For more thorough understanding of the present invention and advantages thereof, the following description should be read in conjunction with the accompanying drawings, in which:

FIG. 1 depicts a pickup control signal generating circuit of an optical pickup apparatus according to the present embodiment; and

FIG. 2 is a schematic drawing for explaining an optical system of the optical pickup apparatus according to the present embodiment.

### DETAILED DESCRIPTION OF THE INVENTION

At least the following details will become apparent from descriptions of this specification and of the accompanying drawings.

The present invention relates to an optical pickup apparatus configured to be capable of carrying out signal reading operations and signal recording operations by focusing laser light of a single laser beam on a signal recording layer formed on an optical disc without the laser light emitted from the laser diode separating.

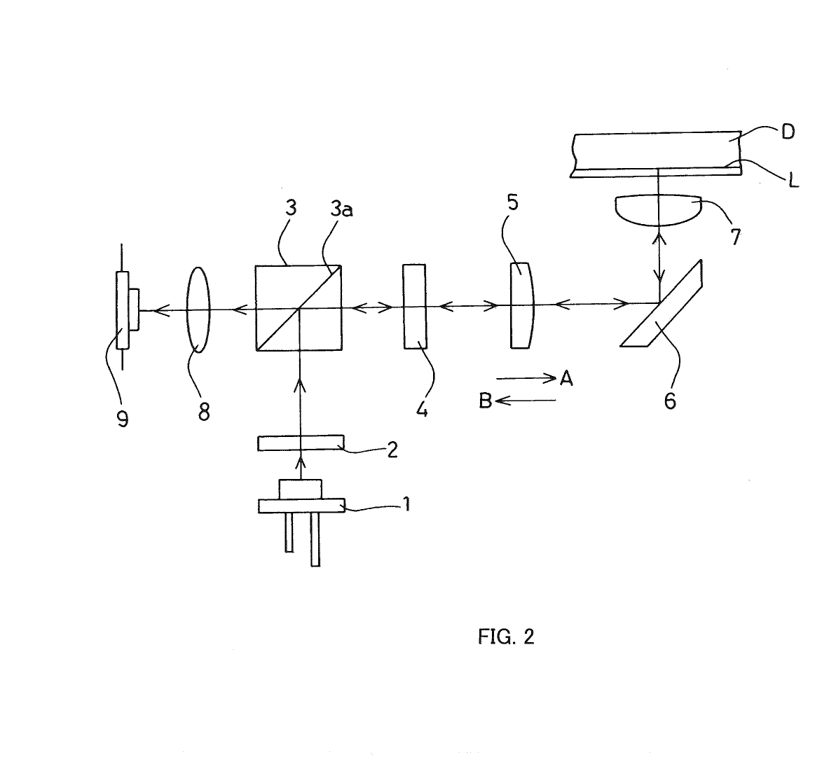

FIG. 2 depicts an optical system of the optical pickup apparatus according to the present embodiment. In FIG. 2, reference numeral 1 denotes a laser diode that emits, for example, laser light having a wavelength appropriate for reading signals recorded on a signal recording layer L formed on an optical disc D conforming to the Blu-ray standard and for recording signals on the above mentioned signal recording layer L.

Reference numeral 2 denotes a half-wave plate that receives incoming laser light emitted from the laser diode 1 and that converts this laser light into P-polarized light, reference numeral 3 denotes a polarizing beam splitter that receives incoming laser light having passed through the half-wave plate 2 and that has a control film 3a that reflects P-polarized light but transmits S-polarized light.

Reference numeral 4 denotes a quarter-wave plate that receives incoming laser light reflected by the control film 3a formed on the polarizing beam splitter 3 and that converts incoming laser light from linearly polarized light into circularly polarized light or reversely from circularly polarized light into linearly polarized light. Reference numeral 5 denotes a collimating lens that receives incoming laser light having passed through the quarter-wave plate 4 and that converts the incoming light from diverging light into parallel light or reversely from parallel light into convergent light. The collimating lens 5 is shifted in the direction of the optical axis, that is, the direction of arrows A and B by rotational drive force by a motor, etc., (not depicted) to correct spherical aberration.

Reference numeral 6 denotes a raising reflection mirror that is disposed at a position where laser light having passed through the collimating lens 5 is made incident on the raising reflection mirror and that is configured to reflect the incident laser light toward the objective lens 7. The objective lens 7 focuses incident laser light onto the signal recording layer L formed on the optical disc D.

Laser light emitted from the laser diode 1 travels along a light path formed with the above optical components and enters the objective lens 7. As a result, through the focus operation of the objective lens 7, laser light is focused onto the signal recording layer L of the optical disc D, where a laser spot appropriate for reading signals recorded on the signal recording layer L of the optical disc D and a laser spot appropriate for recording signals on the signal recording layer L are generated.

Through such process, a laser spot is formed on the signal recording layer L of the optical disc D. At the same time, laser light is reflected back as optical feedback, from the signal recording layer L.

Optical feedback being laser light reflected by the signal recording layer L in the above manner, travels through the objective lens 7, the raising reflection mirror 6, the collimating lens 5, and the quarter-wave plate 4 to enter the polarizing beam splitter 3. As is well known, such optical feedback is converted into linearly polarized light having a different polarization direction, i.e., S-polarized light through phase change operation by the quarter-wave plate 4. Optical feedback, therefore, passes through the control film 3a without being reflected by the control film 3a of the polarizing beam splitter 3.

Reference numeral 8 denotes a sensor lens that is disposed at a position where optical feedback having passed through the control film 3a is incident on and that generates an astigmatism as well as irradiates optical feedback onto a light-receiving portion provided to the photodetector 9.

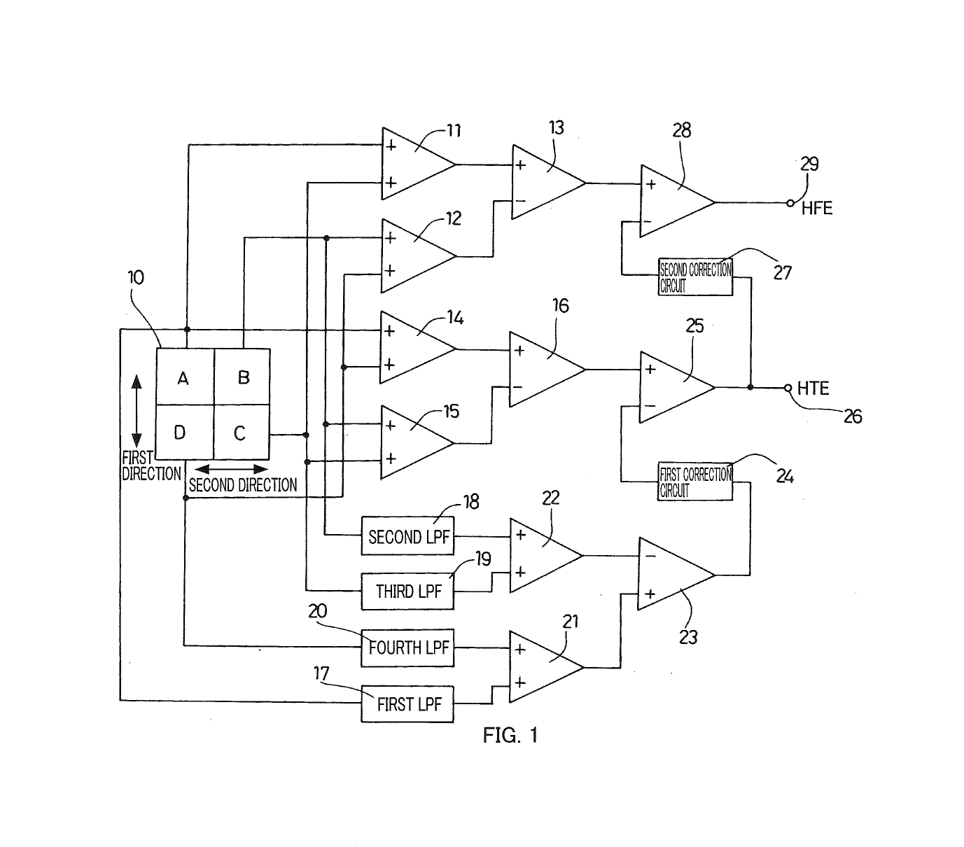

FIG. 1 depicts the light-receiving portion provided to the photodetector 9 and a signal generating circuit that generates a pickup control signal, such as a focus error signal and a tracking error signal, from a signal acquired by the light-receiving portion.

Reference numeral 10 denotes a quartered light-receiving portion provided in the photodetector 9. As depicted in FIG. 1, the light-receiving portion 10 is composed of a first light-receiving portion A, a second light-receiving portion B, a third light-receiving portion C, and a fourth light-receiving portion D, each of them being quadrants created by dividing perpendicularly the light-receiving portion 10 in a second direction optically corresponding to a tracking direction and in a first direction optically corresponding to the direction orthogonal to the tracking direction.

With the photodetector having such a configuration, the focus error signal FE is calculated from FE=(A+C)−(B+D), and the tracking error signal TE is calculated from TE=(A+D)−(B+C). As mentioned before, the focus error signal calculated in this manner is subjected to the influence of disturbance caused by the irregular shape of the guide groove and the like, formed on the optical disc, which poses a problem that an accurate focus error signal cannot be obtained.

The present embodiment, which offers a solution to such problem, will be described in detail referring to FIG. 1. In FIG. 1, 11 denotes a first adding circuit that adds signal A from the first light-receiving portion A and signal C from the third light-receiving portion C, both light-receiving portions A and C constituting the quartered light-receiving portion 10, to output a first addition signal, 12 denotes a second adding circuit that adds signal B from the second light-receiving portion B and signal D from the fourth light-receiving portion D to output a second addition signal, and 13 denotes a first subtracting circuit that subtracts an output signal from the second adding circuit 12 from an output signal from the first adding circuit 11. The first subtracting circuit 13 outputs the aforementioned focus error signal FE given by the equation: FE=(A+C)−(B+D), from its output terminal. The first light-receiving portion A and the third light-receiving portion C are arranged in one diagonal direction of the quartered light-receiving portion 10, while the second light-receiving portion B and the fourth light-receiving portion D are arranged in another diagonal direction of the same. A group consisting of the first adding circuit 11, the second adding circuit 12, and the first subtracting circuit 13 corresponds to a first generating unit.

Reference numeral 14 denotes a third adding circuit that adds signal A from the first light-receiving portion A and signal D from the fourth light-receiving portion D, both light receiving portions A and D constituting the aforementioned quartered light-receiving portion 10, to output a third addition signal, 15 denotes a fourth adding circuit that adds signal B from the second light-receiving portion B and signal C from the third light-receiving portion C to output a fourth addition signal, and 16 denotes a second subtracting circuit that subtracts an output signal from the fourth adding circuit 15 from an output signal from the third adding circuit 14. The second subtracting circuit 16 computes and outputs the aforementioned tracking error signal TE given by the equation: TE=(A+D)−(B+C), from its output terminal. A pair of the first light-receiving portion A and the fourth light-receiving portion D and a pair of the second light-receiving portion B and the third light-receiving portion C are each arranged in the first direction. A group consisting of the third adding circuit 14, the fourth adding circuit 15, and the second subtracting circuit 16 corresponds to a second generating unit.

Reference numeral 17 denotes a first low-pass filter to which the signal A from the first light-receiving portion A is input. The first low-pass filter 17 outputs signal Af from which high-frequency components are cut off, from its output terminal. Reference numeral 18 denotes a second low-pass filter to which the signal B from the second light-receiving portion B is input. The second low-pass filter 18 outputs signal Bf from which high-frequency components are cut off, from its output terminal. Reference numeral 19 denotes a third low-pass filter to which the signal C from the third light-receiving portion C is input. The third low-pass filter 19 outputs signal Cf from which high-frequency components are cut off, from its output terminal. Reference numeral 20 denotes a fourth low-pass filter to which the signal D from the fourth light-receiving portion D is input. The fourth low-pass filter 20 outputs signal Df from which high-frequency components are cut off, from its output terminal. In this configuration, cut-off frequencies for the first low-pass filter 17, second low-pass filter 18, third low-pass filter 19, and fourth low-pass filter 20 are set to several kHz.

Reference numeral 21 denotes a fifth adding circuit that adds output signals from the first low-pass filter 17 and fourth low-pass filter 20. The fifth adding circuit 21 outputs signal (Af+Df) from its output terminal. Reference numeral 22 denotes a sixth adding circuit that adds up output signals from the second low-pass filter 18 and third low-pass filter 19. The sixth adding circuit 22 outputs signal (Bf+Cf) from its output terminal. Reference numeral 23 denotes a third subtracting circuit that subtracts an output signal from the sixth adding circuit 22 from an output signal from the fifth adding circuit 21. The third subtracting circuit 23 outputs calculated signal (Af+Df)−(Bf+Cf), from its output terminal. A group consisting of the fifth adding circuit 21, the sixth adding circuit 22, and the third subtracting circuit 23 corresponds to a third generating unit. The calculated signal output from the third subtracting circuit 23 is a first correction signal for correcting a focus error signal.

Reference numeral 24 denotes a first correction circuit to which an output signal from the third subtracting circuit 23 is input. The first correction circuit 24 corrects a level of an output signal from the third subtracting circuit 23 and fluctuating DC caused by a shifting movement of the objective lens. The first correction circuit 24 multiplies the first correction signal by a correction factor, which is set to, for example, kt.

Reference numeral 25 denotes a fourth subtracting circuit that subtracts an output signal from the third subtracting circuit 23 that is corrected by the first correction circuit 24, from an output signal from the second subtracting circuit 16. The fourth subtracting circuit 25 computes and outputs a corrected tracking error signal HTE (second correction signal) given by the equation: HTE=(A+D)−(B+C)−kt×((Af+Df)−(Bf+Cf)), from its output terminal 26.

Reference numeral 27 denotes a second correction circuit to which the output signal HTE from the fourth subtracting circuit 25 is input. The second correction circuit 27 corrects such as a level of an output signal from the fourth subtracting circuit 25 and a delay in a push-pull signal caused by the low-pass filter. The second correction circuit 27 multiplies a second correction signal by a correction factor, which is set to, for example, kf.

Reference numeral 28 denotes a fifth subtracting circuit that subtracts an output signal from the fourth subtracting circuit 25 that is corrected by the second correction circuit, from an output signal from the first subtracting circuit 13. The fifth subtracting circuit 28 computes and outputs a corrected focus error signal HFE given by the equation: HFE=(A+C)−(B+D)−kf×HTE, i.e., HFE=(A+C)−(B+D)−kf×((A+D)−(B+C)−kt×((Af+Df)−(Bf+Cf))), from its output terminal 29.

As described above, the corrected focus error signal HFE output from the output terminal 29 is obtained by correcting the focus error signal FE calculated and output from the first subtracting circuit 13, using a signal obtained from a tracking error signal. Thereby, influences caused by disturbance due to the irregular shape of the guide groove and the like can be corrected. According to this embodiment, therefore, a single-beam optical pickup apparatus can carry out accurate focus control operation.

Since single optical feedback (single beam tracking) is adopted, the tracking error signal generated by the second subtracting circuit 16 would cause fluctuating DC offset due to decentering of the optical disk or shifting of the lens (movement between the inner circumference and the outer circumference). If calculation is performed with the tracking error signal including a DC offset component input into the fifth subtracting circuit 28 as it is, DC offset components due to decentering of the optical disk or shifting of the lens would remain in the focus error signal. An HTE signal with the DC offset component due to decentering of the optical disk or shifting of the lens removed can be obtained by calculating the signal (amount corresponding to the DC offset) generated by the third subtracting circuit 23 using the fourth subtracting circuit 25. As a result, effective HFE and HTE signals having removed DC offset fluctuation caused by decentering of the optical disk or shifting of the lens can be obtained.

Note that in the present embodiment, the focus error signal FE calculated and output by the first subtracting circuit 13 is corrected using a signal obtained by correcting the output signal HTE from the fourth subtracting circuit 25. However, this correction process is carried out in order to eliminate DC fluctuations included in the tracking error signal from the focus error signal. If DC fluctuations are neglected, the correction process may be carried out in another way such that an output signal from the third subtracting circuit 23 is corrected through the correction circuit and the resulting correction signal is used to correct the focus error signal FE.

The present embodiment has been described for a case performed on an optical pickup apparatus capable of reading and recording signals from and on an optical disc conforming to the Blu-ray standard. The present embodiment, however, may also be applied to an optical pickup apparatus configured to read and record signals from and on optical discs conforming to a standard different from the Blu-ray standard.

According to the present embodiment, the focus error signal FE is corrected using the corrected tracking error signal HTE, which is obtained by adding signals that are sent through the low-pass filters from the light-receiving portions arranged in the tracking direction among the four light-receiving portions composing the quartered light receiving unit provided to generate a focus error signal and a tracking error signal and then carrying out subtraction between two added signals. As a result, accurate focus error signals can be obtained, thereby enabling accurate focus control operation.

Further, according to the present embodiment, an accurate focus error signal can be generated using single optical feedback so that there is no need for a diffraction grating that divides laser light into three laser beams unlike the differential astigmatic method that requires one. Hence the present embodiment offers a simplified optical configuration, thereby reducing the manufacturing cost of the optical pickup apparatus.

The above embodiments of the present invention are simply for facilitating the understanding of the present invention and are not in any way to be construed as limiting the present invention. The present invention may variously be changed or altered without departing from its spirit and encompass equivalents thereof.

What is claimed is:

1. An optical pickup apparatus comprising:
a photodetector including first to fourth light-receiving portions obtained by dividing the photodetector into four portions along a first direction optically corresponding to a direction orthogonal to a tracking direction and a second direction optically corresponding to the tracking direction, the photodetector configured to be irradiated with a laser light applied to a signal recording layer of an optical disc and thereafter reflected by the signal recording layer of the optical disc;
a first generating unit configured to generate a focus error signal by performing subtraction on a first addition signal obtained by adding respective signals from the first and third light-receiving portions, arranged in one diagonal direction, among the first to fourth light-receiving portions, and a second addition signal obtained by adding respective signals from the second and fourth light-receiving portions arranged in another diagonal direction among the first to fourth light-receiving portions;
a second generating unit configured to generate a tracking error signal by performing subtraction on a third addition signal obtained by adding respective signals from the first and fourth light-receiving portions arranged in the first direction, and a fourth addition signal obtained by adding respective signals from the second and third light-receiving portions arranged in the first direction;
first to fourth low-pass filters configured to allow respective signals to be input thereto from the first to fourth light-receiving portions;
a third generating unit configured to generate a first correction signal for correcting the focus error signal by performing subtraction on a fifth addition signal obtained by adding respective signals from the first and fourth low-pass filters, and a sixth addition signal obtained by adding respective signals from the second and third low-pass filters; and
a correction unit configured to correct the focus error signal based on the first correction signal.

2. The optical pickup apparatus of claim 1, wherein the correction unit
includes a first correction unit configured to multiply the first correction signal by a first correction factor for correcting a level of the first correction signal, and wherein
the correction unit is configured to correct the focus error signal based on a correction signal obtained from the first correction unit.

3. The optical pickup apparatus of claim 2, wherein
the correction unit further includes:
a fourth generating unit configured to generate a second correction signal by performing subtraction on the tracking error signal obtained from the second generating unit, and the correction signal obtained from the first correction unit; and
a second correction unit configured to multiply the second correction signal by a second correction factor for correcting a level of the second correction signal, and wherein
the correction unit is configured to correct the focus error signal based on a correction signal obtained from the second correction unit.

4. The optical pickup apparatus of claim 3, wherein
the correction unit further includes a fifth generating unit configured to generate a corrected focus error signal by performing subtraction on the focus error signal obtained from the first generating unit, and the correction signal obtained from the second correction unit.

5. The optical pickup apparatus of claim 4, wherein
the second correction signal includes a corrected tracking error signal.
